(19) United States
(12) Patent Application Publication
(10) Pub. No.: US 2010/0202709 A1
(43) Pub. Date: Aug. 12, 2010

(54) PROCESS AND APPARATUS

(76) Inventors: Alan Francis Heavens, Roslin (GB); Benjamin David Panter, Morningside (GB); Robert John Tweedie, West Powburn Newington (GB); William James Hossack, Edinburgh (GB); Mark Elliott Bastin, Edinburgh (GB)

Correspondence Address: WINSTEAD PC, P.O. BOX 50784, DALLAS, TX, 75201, US

(21) Appl. No.: 12/678,766

(22) PCT Filed: Sep. 24, 2008
(86) PCT No.: PCT/GB2008/003223

§ 371 Date: Apr. 21, 2010

(30) Foreign Application Priority Data
Sep. 24, 2007 (GB) 0718590.3

(51) Int. Cl. G06K 9/36

(52) U.S. Cl. 382/248

(57) ABSTRACT

The present invention relates to a process of bringing at least one subject data set into registration or conformity with a reference data set by electronic methods, each data set being a representation of a respective object. The process comprises: generating each of a plurality of candidate data sets (32) by applying a transformation to a reference data set, the transformation having predetermined variables that are changed such that each of the plurality of candidate data sets is a differently shifted or distorted reference data set; compressing each of the plurality of candidate data sets (34) to form a respective compressed candidate data set and compressing a subject data set (36) to form a compressed subject data set, the step of compressing comprising: determining a plurality of weighting vectors in dependence upon the predetermined variables, the number of weighting vectors being equal to the number of predetermined variables; multiplying all data in a candidate or subject data set by each weighting vector to provide respective, corresponding data elements of the compressed candidate or subject data set; comparing the compressed subject data set with each of the compressed candidate data sets and, in dependence on the comparisons, determining the transformation that has generated the candidate data set corresponding to the compressed candidate data set, which, of the plurality of compressed candidate data sets, provides a best match with the compressed subject data set (38, 40); and applying an inverse of the determined transformation to the subject data set (42).

### FIELD OF THE INVENTION

The present invention relates to a process of bringing at least one subject data set into registration or conformity with a reference data set by electronic methods, a computer program comprising program instructions for causing a computer to perform the same process, and electrical apparatus operative to bring at least one subject data set into registration or conformity with a reference data set.

### BACKGROUND TO THE INVENTION

A Magnetic Resonance Imaging (MRI) scanner may be used to acquire a series of two or three dimensional images of a part, such as the head, of a human or animal subject. A reconstruction of the part of the human or animal subject may be formed by superimposing the acquired two or three dimensional images. Acquiring sufficient two or three dimensional images to form a required reconstruction can take a considerable period of time. During such time, the human or animal subject is liable to move with such movement requiring registration of the acquired images with each other to form a properly reconstructed image. Also, under certain circumstances operation of the MRI scanner can cause distortion of an acquired image, which requires processing of the distorted image to bring it into conformity with the other acquired images.

It is known to bring images into registration with each other. According to such known approaches, the images are acquired and the registration is performed after the acquisition of the images. The present inventors have appreciated that such known approaches to image registration have shortcomings.

It is therefore an object for the present invention to provide a process of bringing at least one subject data set into registration or conformity with a reference data set by electronic methods, each data set being a representation, e.g. an image, of a respective object, such as part of the human or animal body.

It is a further object for the present invention to provide electrical apparatus operative to bring at least one subject data set into registration or conformity with a reference data set, each data set being a representation, e.g. an image, of a respective object, such as part of the human or animal body.

### STATEMENT OF INVENTION

The present invention has been devised in the light of the inventors' appreciation of shortcomings of known registration approaches. Thus, according to a first aspect of the present invention, there is provided a process of bringing at least one subject data set into registration or conformity with a reference data set by electronic methods, each data set being a representation of a respective object, the process comprising:
generating each of a plurality of candidate data sets by applying a transformation to a reference data set, the transformation having predetermined variables that are changed such that each of the plurality of candidate data sets is a differently shifted or distorted reference data set;
compressing each of the plurality of candidate data sets to form a respective compressed candidate data set and compressing a subject data set to form a compressed subject data set, the step of compressing comprising: determining a plurality of weighting vectors in dependence upon the predetermined variables, the number of weighting vectors being equal to the number of predetermined variables; multiplying all data in a candidate or subject data set by each weighting vector to provide respective, corresponding data elements of the compressed candidate or subject data set;
comparing the compressed subject data set with each of the compressed candidate data sets and, in dependence on the comparisons, determining the transformation that has generated the candidate data set corresponding to the compressed candidate data set, which, of the plurality of compressed candidate data sets, provides a best match with the compressed subject data set; and
applying an inverse of the determined transformation to the subject data set.

In use, the application of the inverse of the determined transformation may bring the subject data set substantially into registration or conformity with the reference data set. Also, the application of the inverse of the determined transformation to the subject data set may provide a registered or conforming subject data set.

The process of the present invention may provide for a significant lightening of the computational burden compared with known approaches to data set registration. For example, a three-dimensional reference data set may comprise 512 by 512 by 54 elements and 500,000 candidate data sets may be formed from the reference data set. In contrast, the transformation may have a comparatively small number of predetermined variables, e.g. twelve variables, which means a compressed subject data set has twelve elements and each compressed candidate data set has twelve elements. Thus, the computational burden of comparing a compressed subject data set with each compressed candidate data set is significantly lighter than the computational burden of comparing a subject data set with each candidate data set. Hence, the process of the present invention may be performed in real time, e.g. during acquisition of images from an MRI scanner instead of waiting for completion of the acquisition of the images before registration is started. In forms of the invention, a transformation may consist of a complement of variables and the predetermined number of variables may be fewer than the complement of variables. For example, the complement of variables may consist of twelve variables and the predetermined variables may consist of six variables; thus, the compression may involve only six of the twelve variables.

The step of determining a plurality of weights may comprise determining a rate of change of a data set, which is undergoing compression, with respect to at least one of the predetermined variables. The rate of change may have the form of a vector. More specifically, each of the plurality of weights may be determined in dependence on a rate of change of the data set with respect to a respective one of the predetermined variables.

Alternatively or in addition, a rate of change of a data set may be determined by: applying each of a plurality of predetermined values for a predetermined variable to the data set to form corresponding intermediate data sets; and determining the rate of change on the basis of the intermediate data sets. The plurality of predetermined values may consist of two predetermined values. Thus, a rate of change of a data set may be determined by: applying a predetermined value that is lower, e.g. 0.99, than a nominal value, such as unity, and a predetermined value that is higher, e.g. 1.01, than the nominal value to the data set to form a first intermediate data set and a second intermediate data set respectively; determining a difference between the first intermediate data set and the second intermediate data set to form a difference data set; and dividing the difference data set by a difference between the lower and higher predetermined values. Thus, where each of the plurality of weights is determined in dependence on a rate of change of the data set with respect to a respective one of the predetermined variables, a rate of change of the data set is formed for each of the plurality of predetermined variables.

Alternatively or in addition, a first weighting vector may be determined in dependence on a first rate of change determined with respect to a first predetermined variable and a second weighting vector may be determined in dependence on the first weighting vector and a second rate of change determined with respect to a second predetermined variable. More specifically, the second weighting vector may be determined in dependence on subtraction of a product of the first weighting vector and a transpose of the second rate of change from the second rate of change.

Alternatively or in addition, a third weighting vector may be determined in dependence on the first and second weighting vectors and a third rate of change determined with respect to a third predetermined variable. Thus, a subsequent weighting vector may be determined in dependence on all previously determined weighting vectors and a subsequent rate of change determined with respect to a subsequent predetermined variable. More specifically, the third weighting vector may be determined in dependence on: summing a product of the first weighting vector and a transpose of the third rate of change and a product of the second weighting vector and a transpose of the third rate of change; and subtracting the summation from the third rate of change. Thus, a subsequent weighting vector may be determined in dependence on: summing products of each previously determined weighting vector with a transpose of the subsequent rate of change; and subtracting the summation from the subsequent rate of change.

Alternatively or in addition, the step of determining a plurality of weights may further comprise determining a noise vector, the noise vector being determined on the basis of noise present in a data set undergoing compression. More specifically, the noise vector may be determined on the basis of white noise of predetermined amplitude being present in the data set undergoing compression.

Alternatively or in addition, the step of determining a plurality of weights may further comprise determining a noise covariance matrix. More specifically, a weighting vector may be determined in dependence on a product of a corresponding rate of change and the noise covariance matrix. Alternatively or in addition, the noise covariance matrix may be a diagonal matrix having a value of 1/σ² for each element in the main diagonal.

Alternatively or in addition, a data set undergoing compression may comprise N elements of data, the N elements of data being represented by a vector xᵢ, i=1, . . . N. Alternatively or in addition, the plurality of variables may comprise M variables. More specifically, the plurality of weighting vectors may consist of M vectors bₘ, m=1, . . . M.

Alternatively or in addition, a first weighting vector may be:

b₁=C⁻¹μ_{,1}/\sqrt{μ_{,1}^{t}C⁻¹μ_{,1}}

and each subsequent weighting vector may be:

$${b}_{m} = ( {C}^{- 1} {μ}_{, m} - {\sum }_{q = 1}^{m - 1} ( {μ}_{, m}^{t} {b}_{q} ) {b}_{q} ) / \sqrt{{μ}_{, m}^{t} {C}^{- 1} {μ}_{, m} - {\sum }_{q = 1}^{m - 1} {( {μ}_{, m}^{t} {b}_{q} )}^{2}}$$

where C is a noise covariance matrix and p, is the rate of change.

Alternatively or in addition, the step of multiplying all data in a candidate or subject data set by each weighting vector may comprise computing the scalar product of the data set and each weighting vector to provide the corresponding, respective data elements.

Alternatively or in addition, the transformation may be one of: an affine transformation; and a warp transformation, such as an elastic transformation.

More specifically, the transformation may be an affine transformation comprising variables for performing at least one of: at least one translation; at least one rotation; at least one scale; and at least one shear. More specifically, the affine transformation may comprise variables for performing: translations in each of three mutually orthogonal directions; rotation about each of three mutually orthogonal axes; scales along each of three mutually orthogonal directions; and shears along each pair of pairs of three mutually orthogonal directions. Thus, the affine transformation may consist of twelve variables and therefore a compressed data set that has been compressed in dependence on the affine transformation may consist of twelve data elements.

Alternatively or in addition, the step of applying a transformation to a reference data set may comprise multiplying the reference data set with each of a plurality of forms of the transformation, each of the plurality of forms of the transformation having a value for at least one variable that differs from the other forms of the transformation.

Alternatively or in addition, the plurality of candidate data sets may consist of at least 100,000 candidate data sets. The number of predetermined variables may be no more than substantially 100.

Alternatively or in addition, the process may further comprise the step of formatting at least one of the candidate data sets after the step of applying a transformation to the reference data set and before the step of compressing each of the candidate data sets. More specifically, the step of formatting a candidate data set may comprise changing elements of the candidate data set such that the elements of the candidate data set have a same spatial disposition as elements of the reference data set. Alternatively or in addition, changing an element of the candidate data set may comprise interpolation between or amongst elements neighbouring the element being changed. More specifically, interpolation may comprise linear interpolation in at least two dimensions.

Alternatively or in addition, the step of comparing the compressed subject data set with each of the compressed candidate data sets may comprise comparing by means of at least one of: estimation of likelihood; and a chi-squared test.

More specifically, the steps of generating each of a plurality of candidate data sets and compressing the data sets may be repeated such that a larger plurality of candidate data sets are generated from the reference data set than previously, the steps being repeated in dependence on the step of comparing the compressed subject data set with each of the compressed candidate data sets. Thus, if a best match is determined to be insufficiently close for a particular application of the invention, a larger plurality of candidate data sets may be generated, whereby a closer matching candidate data set may be determined.

Alternatively or in addition, the step of comparing the compressed data set may comprise determining a plurality of transformations that have generated candidate data sets corresponding to respective compressed candidate data sets, which, of the plurality of compressed data sets provide best matches with the compressed subject data set. Thus, the process of the present invention may be used to determine a plurality of transformations, e.g. up to 100 of a total number of 500,000 transformations, which of all the transformations provide the best, i.e. closest, matches.

Alternatively or in addition, the process may further comprise determining at least one further candidate data set on the basis of the at least one determined transformation. More specifically, the at least one further candidate data set may be determined on the basis of the at least one respective candidate data set corresponding to the at least one determined transformation. Thus, for example, where three transformations have been determined according to the process, a further candidate data set may be determined for each of the three transformations. A further candidate data set may be compared with the subject data set by means of a goodness of fit method of a kind described herein. Where there is a plurality of further candidate data sets, one of the further candidate data sets may be selected in dependence on the goodness of fit measures for each of the plurality of further candidate data sets.

More specifically, the process may further comprise determining at least one further candidate data set by a univariate method, such as Powells method.

Alternatively or in addition, the process may further comprise filtering at least one of the reference data set and the at least one subject data set by means of a filter. More specifically, the filter may be a low-pass filter. Alternatively or in addition, the filter may be a Gaussian filter. At least one characteristic may be no more than substantially 10% of a corresponding characteristic of the data set being filtered. For example, where a data set represents an image of 250 mm by 250 mm by 250 mm, the depth, height and width characteristics of the filter may be no more than 25 mm by no more than 25 mm by no more than 25 mm respectively. Filtering a data set may have the effect of blurring the representation provided by the data set. The blurring of the representation can improve the effectiveness of the determining of the best match of compressed subject data set with the compressed candidate data sets. Alternatively or in addition, filtering may be used to reduce the size of a data set. For example, filtering may involve taking every second element of a data set. For example, filtering may involve selecting a portion of a data set by an operation such as cropping a data set.

Alternatively or in addition, a data set may be a representation of an object in at least two dimensions.

Alternatively or in addition, the reference data set and the subject data set may be time spaced representations of an object. Alternatively or in addition and where the process comprises bringing each of a plurality of subject data sets into registration or conformity with a reference data set, the plurality of subject data sets may be time spaced representations of an object.

Alternatively or in addition, a data set may be representation of an image, such as an MRI image, of an object, such as a part of the human or animal body.

Alternatively or in addition, the process may further comprise acquiring the at least one subject data set from the object by electronic methods. More specifically, the step of acquiring the at least one subject data set may be performed by at least one of: a MRI scanner; a Computed Tomography (CT) scanner; a Positron Emission Tomography (PET) scanner; ultrasound apparatus; and an X-ray apparatus.

Alternatively or in addition, the process may further comprise acquiring the representation of the at least one subject data set from the object by electronic methods before executing the step of generating each of the plurality of candidate data sets.

Alternatively or in addition, the process may further comprise providing a registered or conforming data set in dependence upon the step of applying the inverse of the determined transformation.

More specifically, the process may further comprise outputting the registered or conforming data set as part of a representation to at least one of: a Visual Display Unit (VDU); a film; and a Picture, Archiving and Communications (PACS) system.

Alternatively or in addition, the process may further comprise converting the registered or conforming data set to a Digital Imaging and Communications in Medicine (DICOM) format.

Alternatively or in addition, the reference data set and the at least one subject data set may have been acquired from different acquisition apparatus. For example, the reference data set may have been acquired by a CT scanner and the at least one subject data set may have been acquired from an MRI scanner. Alternatively or in addition, the reference data set and the at least one subject data set may be representations of different forms of an object. For example, the reference data set may be a representation of a head of a first human subject and the at least one subject data set may be a representation of a head of a second human subject. Alternatively or in addition, the reference data set may be one of: a previously acquired data set of a same kind as the subject data set; and one of a library of stored reference data sets.

The subject data set and the reference data set may be in the form of digital data. The plurality of candidate data sets may be in the form of digital data. The step of generating each of the plurality of candidate data sets may be performed by digital processing. The step of compressing each of the plurality of candidate data sets may be performed by digital processing. The step of comparing the compressed subject data set with each of the compressed candidate data sets may be performed by digital processing. The step of applying the inverse of the determined transformation may be performed by digital processing.

The subject data set and the reference data set may be stored as an electronic signal. The plurality of candidate data sets may be stored as an electronic signal. The compressed data sets may be stored as an electronic signal. Generation of each of a plurality of candidate data sets may be by operation of at least one of: a Central Processing Unit (CPU); and a Graphics Processing Unit (GPU). Compression of a data set may be by operation of at least one of: a Central Processing Unit (CPU); and a Graphics Processing Unit (GPU). Comparing the compressed subject data set with each of the compressed candidate data sets may be by operation of at least one of: a Central Processing Unit (CPU); and a Graphics Processing Unit (GPU). Applying the inverse of the determined transformation may be by operation of at least one of: a Central Processing Unit (CPU); and a Graphics Processing Unit (GPU).

According to a second aspect of the present invention, there is provided a computer program comprising program instructions for causing a computer to perform the process according to the first aspect of the present invention.

More specifically, the computer program may be one of: embodied on a record medium; embodied in a read-only memory; stored in a computer memory; and carried on an electrical carrier signal.

Further embodiments of the second aspect of the present invention may comprise one or more features of the first aspect of the present invention.

According to a third aspect of the present invention, there is provided a computer system comprising program instructions for causing a computer to perform the process according to the first aspect of the present invention.

More specifically, the program instructions may be one of: embodied on a record medium; embodied in a read-only memory; stored in a computer memory; and carried on an electrical carrier signal.

Further embodiments of the third aspect of the present invention may comprise one or more features of the first aspect of the present invention.

According to a fourth aspect of the present invention, there is provided electrical apparatus operative to bring at least one subject data set into registration or conformity with a reference data set according to the first aspect of the present invention, the electrical apparatus comprising a digital processor and a data store, the digital processor being operative to carry out the steps of: generating each of the plurality of candidate data sets; compressing each of the plurality of data sets and compressing the subject data set; comparing the compressed subject data set with each of the compressed candidate data sets; and applying the inverse of the determined transformation, and the data store being operative to store: the at least one subject data set and the reference data set; the plurality of candidate data sets; and the compressed data sets.

More specifically, the electrical apparatus may comprise at least one of: a Central Processing Unit (CPU); and a Graphics Processing Unit (GPU)

Further embodiments of the fourth aspect of the present invention may comprise one or more features of the first aspect of the present invention.

According to a further aspect of the present invention there is provided a process of bringing at least one subject data set into registration or conformity with a reference data set, each data set being a representation of a respective object, the process comprising: generating each of a plurality of candidate data sets by applying a transformation to a reference data set, the transformation having predetermined variables that are changed such that each of the plurality of candidate data sets is a differently shifted or distorted reference data set; compressing each of the plurality of candidate data sets to form a respective compressed candidate data set and compressing a subject data set to form a compressed subject data set, the step of compressing comprising: determining a plurality of weighting vectors in dependence upon the predetermined variables, the number of weighting vectors being equal to the number of predetermined variables; multiplying all data in a candidate or subject data set by each weighting vector to provide respective, corresponding data elements of the compressed candidate or subject data set; comparing the compressed subject data set with each of the compressed candidate data sets and, in dependence on the comparisons, determining the transformation that has generated the candidate data set corresponding to the compressed candidate data set, which, of the plurality of compressed candidate data sets, provides a best match with the compressed subject data set; and applying an inverse of the determined transformation to one of the subject data set and the compressed subject data set.

Embodiments of the further aspect of the present invention may comprise one or more features of any previous aspect of the invention.

### BRIEF DESCRIPTION OF DRAWINGS

Further features and advantages of the present invention will become apparent from the following specific description, which is given by way of example only and with reference to the accompanying drawings, in which:

FIG. 1 is a block diagram representation of apparatus that is operable according to the present invention;

FIG. 2 shows a flow chart representation of a process according to the present invention; and

FIGS. 3A, 3B and 3C show a reference image, an acquired image and a registered form of the acquired image respectively.

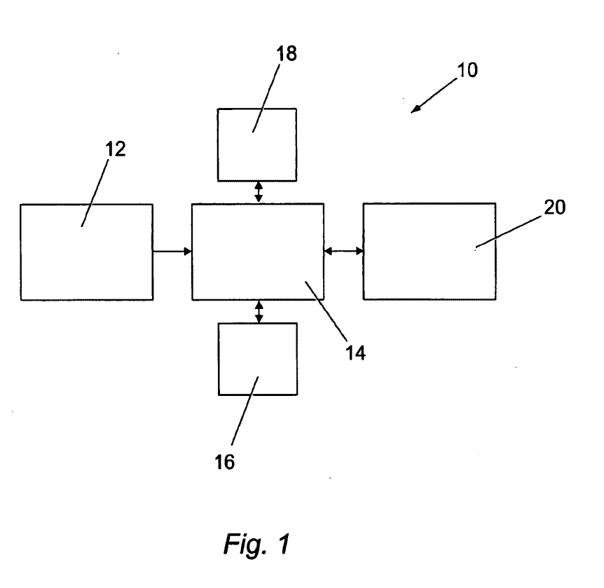

An apparatus 10 that is operable according to the invention is shown in block diagram form in FIG. 1. The apparatus 10 comprises a Magnetic Resonance Imaging (MRI) scanner 12, which is operable to acquire images (which constitute representations) from a part of a human or animal subject or indeed of an inanimate object that is susceptible to scanning with an MRI scanner. During acquisition of the images the human or animal subject may move such that the images are out of registration with each other; movement may include rotation or movement from side to side. Also, during acquisition the operation of the MRI scanner may distort images such that the acquired images are out of conformity with each other. Each acquired image is in three dimensions and consists of 512×512×54 pixels. Each acquired image is conveyed to a Central Processing Unit (CPU) or Graphics Processing Unit (GPU) 14 of well-known form, which forms part of conventional computer apparatus. Each acquired image is stored in digital form as a subject data set, which contains 512×512×54 data elements, in the data store 16, which is of conventional form and function. As will be described below in detail the stored subject data sets are brought into registration or conformity with each other to thereby allow for their formation as a three dimensional reconstruction of the part of the human or animal body before the reconstruction is either displayed on a Visual Display Unit (VDU) 18 or conveyed to a Picture, Archiving and Communications (PACS) system 20. The CPU or GPU 14 of FIG. 1 is a general purpose computer, which is programmed to perform the process of the invention by program instructions of conventional form that are stored in read only memory, computer memory or in a record medium, such as an optical disc.

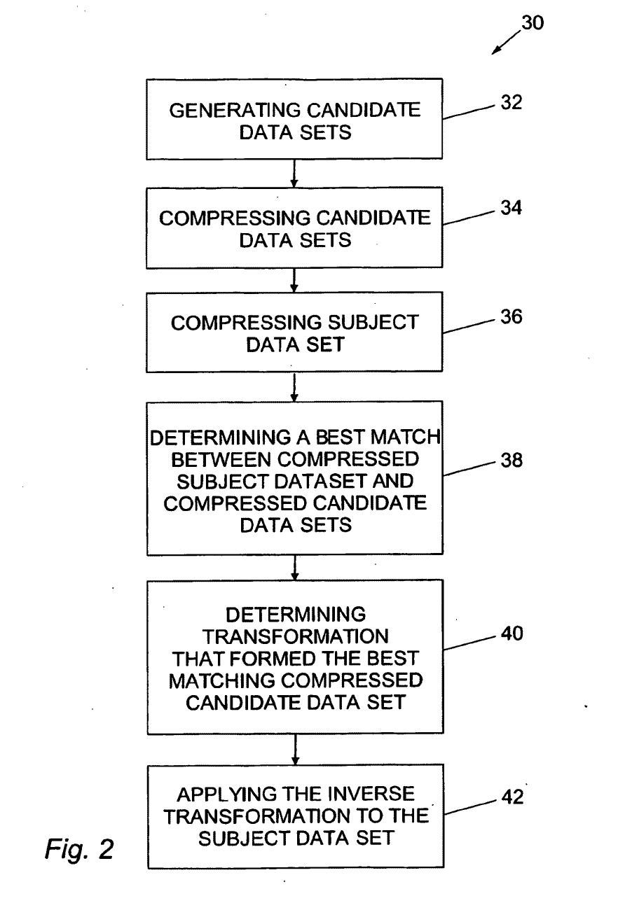

A process according to the present invention will now be described with reference to the flow chart 30 shown in FIG. 2 and the block diagram of FIG. 1. An affine transformation is applied by the CPU or GPU 14 to the reference data set. In this embodiment, the reference data set represents the first acquired image. In other embodiments, the reference data set represents an image acquired from other apparatus, such as a Computed Tomography (CT) scanner, a Positron Emission Tomography (PET) scanner, ultrasound apparatus or X-ray apparatus and with which images acquired from the MRI scanner are to be registered or conformed. In another embodiment, the reference data set represents a library image, e.g. as might be conveyed to the CPU or GPU from the PACS system 20.

The affine transformation applied in the present process has variables for performing: translations in each of three mutually orthogonal directions, i.e. x, y and z directions; rotation about each of three mutually orthogonal axes, i.e. x, y and z axes; scales along each of three mutually orthogonal directions, i.e. x, y and z directions; and a shear along each pair of pairs of three mutually orthogonal directions, i.e. x, y and z directions. Thus, the affine transformation consists of twelve variables. The steps taken to generate the present affine transformation using Maple are set out in Appendix B. The affine transformation is applied repeatedly to the reference data set with values of the variables in the affine transformation being changed from application to application such that a different candidate data set is generated each application. The repeated application of the affine transformation generates in the region of 500,000 to 1,000,000 candidate data sets 32, which are stored in the data store 16. A warp can be used as an alternative to the affine transformation. More specifically an elastic transform, such as a thin plate spline, is used. An example of a thin plate spline is provided in http:mathworld.wolfram.com/ThinPlateSpline.html.

Each of the candidate data sets is then formatted. Affine transformation of a square reference data set may, for example, produce a candidate data set in the form of a parallelogram having angles that are less than or greater than 90 degrees. Thus, the elements of a candidate data set will not have the same spatial disposition as elements of the square reference data set or elements of a square subject data set. More specifically, if the candidate data set were to be superimposed upon a subject data set their elements would not coincide. Therefore, the formatting step changes the elements of each candidate data set such that they have the same spatial disposition as elements of the square reference and subject data sets. Each element of the candidate data set is changed by linear interpolation between the element to be changed and neighbouring elements to determine a value for the changed element at its new location.

Each of the candidate data sets is compressed 34 using a compression process described below. Also, each of second and subsequent acquired data sets, which represent the second and subsequent acquired images, is compressed 36 using the compression process. The compressed data sets are stored in the data store 16. As described in detail below each compressed data set contains twelve data elements.

The second compressed subject data set is compared with each of the compressed candidate data sets by means of an estimation of likelihood or a chi-squared test. The estimation of likelihood or chi-squared test approaches will be described no further as they are well known and will be readily applied to the present invention by the skilled reader. The comparison of compressed data sets with each other involves comparing data sets containing twelve elements and thus presents a significantly lighter computational burden than comparison of the uncompressed data sets, which involves comparing data sets containing 14155776 data elements. After the application of the estimation of likelihood or chi-squared test the best match or up to 100 closest matches are identified 38. Where the best match is identified the form of the affine transformation corresponding to the best match is identified 42 and the inverse of the transformation is applied to the second subject data set to register or bring the subject data set into registration with the first subject data set. The comparison and inverse transformation steps set out in the present paragraph are repeated in respect of each of the subsequent compressed subject data sets to bring each of the subsequent data sets into registration or conformity with the first subject data set. In the event that the best match is deemed insufficiently close according to the matching approach, the steps of FIG. 2 are repeated on the basis of a larger number of candidate data steps being generated at the first step 32 such that a finer resolution of all possible distorted or shifted data sets is produced. A reconstruction of the part of the human or animal body that has been scanned by the MRI scanner is then formed from the registered and conformed subject data sets and displayed on the VDU 18. Alternatively the registered and conformed subject data sets are stored for later retrieval in the data store 16 or converted to DICOM format and conveyed in this format to the PAC system 20.

In a form of the invention, where closest matches are identified or where an improved best match is desired, Powell's method is applied to each of the closest matching uncompressed candidate data sets or the best matching uncompressed candidate data set to generate a further candidate data set or a corresponding number of further candidate data sets. The further candidate data set or each of the further candidate data sets is compared with the uncompressed subject data set undergoing registration by means of an estimation of likelihood or a chi-squared test (as described above) to determine the best match. Powell's method is an approach that will be well know to the skilled reader. Powell's method is described in detail in “Numerical Recipes”, Press, Teukolsky, Vetterling and Flannery (CUP), section 10.7, p 509, “Direction Set Methods in Multidimensions”.

In certain forms of the invention, each of the acquired images are filtered by means of a Gaussian filter having depth 5 mm, height 15 mm and width 15 mm before the steps of FIG. 2 commence, each acquired image having depth 250 mm, height 250 mm and width 250 mm. The filter characteristics depend on the size of features in acquired images as well as the size of the acquired images. Filtering in effect blurs the images, which makes it easier to determine the best matching candidate data set.

The compression method according to the present invention will now be described. The data set being compressed is partially differentiated with respect to each of the variables of the affine transformation to obtain a rate of change of the data set with respect to each variable. For example, for the ‘rotation about the x-axis’ variable, a rotation of +1 degree is applied to the data set being compressed to form a first intermediate data set and a of −1 degree is applied to the data set being compressed to form a second intermediate data set. Then the difference between the first and second intermediate data sets is determined and divided by the difference between the +1 degree and −1 degree rotations, i.e. 2 degrees. The same approach is followed for each of the eleven other variables of the affine transform. The twelve rates of change that have been thus determined are μ,₁ to μ,₁₂. The twelve weighting vectors b₁ to b₁₂ are determined from:

b₁=C⁻¹μ_{,1}/\sqrt{μ_{,1}^{t}C⁻¹μ_{,1}}

for the first weighting vector b₁ and from:

$${b}_{m} = ( {C}^{- 1} {μ}_{, m} - {\sum }_{q = 1}^{m - 1} ( {μ}_{, m}^{t} {b}_{q} ) {b}_{q} ) / \sqrt{{μ}_{, m}^{t} {C}^{- 1} {μ}_{, m} - {\sum }_{q = 1}^{m - 1} {( {μ}_{, m}^{t} {b}_{q} )}^{2}}$$

for the second and subsequent weighting vectors bₘ; m=1 . . . M where:
C is a noise covariance matrix having a value of 1/σ² for each element in the main diagonal so as to represent white noise of a predetermined amplitude; a data set undergoing compression comprises N elements of data, the N elements of data being represented by a vector xᵢ, i=1, . . . N; the plurality of variables comprise M variables; and the plurality of weighting vectors consist of M vectors bₘ, m=1, . . . M.

Each element of the compressed data set is then determined by dot product multiplication of each weighting vector with the data set being compressed.

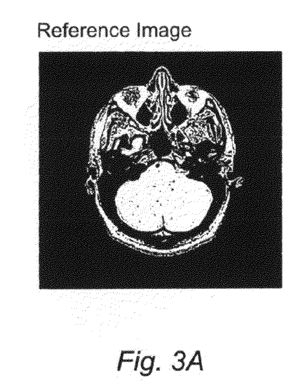

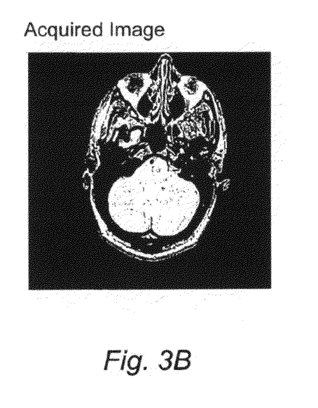

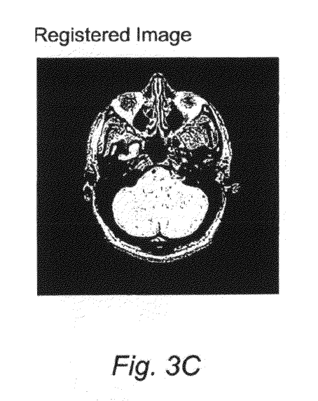

FIG. 3A shows a reference or first acquired image of a human head from the MRI scanner 12 of FIG. 1 as displayed on the VDU 18. FIG. 3B shows a second acquired or subject image of the same human head from the MRI scanner. Comparison of FIGS. 3A and 3B show that the head shown in the image of FIG. 3B is a distorted form of the image of FIG. 3A. More specifically, the head of FIG. 3B is rotated to the right and is elongated in a direction from the nose of the head to the back of the head. FIG. 3C shows a registered and conformed form of the image of FIG. 3B after completion of the process according to the present invention. Comparison of FIGS. 3A and 3C reveals the effectiveness of the present invention.

### APPENDIX A

### Data Compression and the Compression Algorithm

The compression algorithm allows rapid analysis of large datasets through a compression method which is, in most cases, lossless. This chapter contains a summary of the technique developed in TTH, HJL00, RJH01.

### 1.1 The Compression Algorithm

### 1.1.1 An Introduction to Data Compression

Fundamentally, the ideal goal of data compression techniques for parameter estimation is to recover information from a compressed dataset that has the same quality as the information which could be recovered from the original, full dataset. the algorithm assumes that the data, written as a vector, consists of signal, μ, and noise, n, components

x=μ+n. (1.1)

If we assume that the noise causes the data to be randomly distributed around the signal with [symbol] n [symbol] =0, it follows that,

[symbol]

x [symbol] =μ. (1.2)

If noise is assumed to be Gaussian, it can be completely described by the covariance matrix, C, with components Cᵢⱼ= [symbol] nᵢnⱼ [symbol] . For the remainder of this section, the indices i, j refer to data pixels and α, β to parameters. I first consider general linear compression of the data vector x, then focus on the particular compression used by the compression algorithm. This compression is designed to retain as much information (ideally all) about the predetermined parameters as possible.

### Linear Combinations of Data

Let y be a vector of linear combinations of the data, produced by multiplying the data vector x by the matrix of weighting vectors B. Using this nomenclature we can describe the data, its mean and its variance:

$$\begin{matrix}{y}_{i} = {B}_{ij} {x}_{j} & \text{(1.3)} \\ 〈 {y}_{i} 〉 = {B}_{ij} 〈 {x}_{j} 〉 , 〈 y 〉 = B μ & ( 1.4 ) \\ 〈 ( {y}_{i} - < {y}_{i} > ) ( {y}_{j} - < {y}_{j} > ) 〉 = 〈 ( {B}_{il} {x}_{l} - {B}_{il} {μ}_{l} ) ( {B}_{jk} {x}_{k} - {B}_{jk} {μ}_{k} ) 〉 & ( 1.5 ) \\ = {B}_{il} {B}_{jk} [ 〈 {x}_{l} {x}_{k} 〉 + {μ}_{l} {μ}_{k} - 〈 {x}_{l} 〉 {μ}_{k} - {μ}_{l} 〈 {x}_{k} 〉 ] & ( 1.6 ) \\ = {B}_{il} {B}_{jk} [ 〈 {x}_{l} {x}_{k} 〉 + {μ}_{l} {μ}_{k} - {μ}_{l} {μ}_{k} - {μ}_{l} {μ}_{k} ] & ( 1.7 ) \\ = {B}_{il} {B}_{jk} {C}_{lk} = {B}_{il} {C}_{lk} {B}_{kj}^{t} & ( 1.8 )\end{matrix}$$

BᵢₗCₗₖBₖⱼ^{t} will appear many times in the following description, and from here onwards will be written BCB^{t}. C is the covariance matrix of the data x:

Cₗₖ= [symbol] (xₗ−μₗ)(xₖ−μₖ) [symbol] = [symbol] xₗxₖ [symbol] −μₗμₖ. (1.9)

These definitions are valid for any weighting vector. In the special case of B being square and non-singular, it is possible to reconstruct the data completely from the y vector since B is invertible—although it is the same length as x so there is zero compression. Although reducing the length of y will reduce the size of the dataset, it will not necessarily lose information about parameters which may be extracted from those data. Since we are more interested in the information that can be extracted from the data than the data itself, we can use the Fisher matrix to determine how much information we lose when we use some combinations of the data determined by B.
1.1.3 Compression with the Algorithm

If the matrix B consists of only one row we can write it as b, a vector. In this case BCB^{t} is bCb^{t}, the product of a vector, a square matrix and a vector—a number. Putting this into the equation above,

$${F}_{αβ} = [ \frac{( b . {μ}_{, α}^{t} ) ( b . {μ}_{, β}^{t} )}{{bCb}^{t}} ] . \qquad ( 1.35 )$$

Earlier the conditional error on θ_{α} was determined to be

$${F}_{αα}^{\frac{1}{2}} .$$

To minimize this error we need to maximize F_{αα};

$${F}_{αα} = [ \frac{{( b . {μ}_{, α} )}^{2}}{( {bCb}^{t} )} ] . \qquad ( 1.36 )$$

Maximizing F_{αα} subject to the condition that bCb^{t}=constant=1, can be achieved with a Lagrange multiplier λ:

$$\begin{matrix}\frac{\partial }{\partial {b}_{i}} ( {[ {{b}_{j} ( {μ}_{, α} )}_{j} ]}^{2} - λ {b}_{j} {C}_{jl} {b}_{l} ) = 0 & ( 1.37 ) \\ 2 [ {{b}_{j} ( {μ}_{, α} )}_{j} ] - λ {C}_{il} {b}_{l} - λ {b}_{j} {C}_{ji} = 0. & ( 1.38 )\end{matrix}$$

since C is symmetric, Cᵢⱼ=Cⱼᵢ.

$$\begin{matrix}⇒ {b}_{j} \underbrace{{( {μ}_{, α} )}_{j}^{t} {( {μ}_{, α} )}_{i}}_{{M}_{ij}} = λ {C}_{il} {b}_{l} & ( 1.39 ) \\ {M}_{ij} {b}_{j} = {λ C}_{il} {b}_{l} & ( 1.40 ) \\ Mb = λ C b . & ( 1.41 )\end{matrix}$$

This is a generalized eigenvalue problem. Since C is by definition a square and symmetric matrix, it can be diagonalized. The resultant matrix would contain the variances of the rotated set, which must all be positive (the eigenvalues along the diagonal are the variances of the now orthogonal data). Since the eigenvalues do not change under rotation, the matrix is positive definite (all terms must be greater than zero). Such problems can be solved using the “Cholesky decomposition”, C=LL^{t}, where L is a lower triangular matrix.

$$\begin{matrix}Mb = λ { \overbrace{{LL}^{t}}}^{C} b & ( 1.42 ) \\ {L}^{- 1} Mb = λ {L}^{t} b & ( 1.43 ) \\ {L}^{- 1} M ( {( {L}^{t} )}^{- 1} {L}^{t} ) b = λ { \underbrace{{L}^{t} b}}_{f} & ( 1.44 ) \\ {\underbrace{[ {L}^{- 1} {M ( {L}^{t} )}^{- 1} ]}}_{N} = λ f & ( 1.45 ) \\ Nf = λ f . & ( 1.46 )\end{matrix}$$

This is an ordinary eigenvalue problem, and can be expanded to

$$\begin{matrix}( {L}^{- 1} {μ}_{, α} ) ( {μ}_{, α} {\underbrace{{( {L}^{t} )}^{- 1} ) {L}^{t}}}_{I} b = λ {L}^{t} b \\ ( = scalar ) & ( 1.47 ) \\ ⇒ {L}^{t} b ∝ {L}^{- 1} {μ}_{, 1} & ( 1.48 )\end{matrix}$$

and setting λ so that bCb^{t}=1 as required:

b=const·(L^{t})⁻¹L⁻¹μ_{,1} (1.49)

b₁=const·C⁻¹μ_{,1} (1.50)

which, when normalised, gives the solution

b₁=C⁻¹μ_{,1}/\sqrt{μ_{,1}^{t}C⁻¹μ_{,1}} (1.51)

Putting this solution into our original compression equation, we get a compressed data set which consists of only one number, y₁, such that

y₁=b₁·x. (1.52)

In addition, the solution appears to work as expected in the simple uncorrelated case, giving high weight to those data which are most sensitive to the parameters (large changes in μ) and low weight to those that are noisy (small C⁻¹ elements). To determine how good the compression is, we need to compare the Fisher matrix elements for the complete and compressed data sets. Substituting b₁ into equation 1.35 gives

F₁₁=μ_{,1}^{t}C⁻¹μ_{,1} (1.53)

which, given C is independent of θ, is identical to the Fisher matrix element when using the full data set. This means that the compression from the whole dataset to a single number is lossless in this sense.

### Caveat

It is important to realize that the compression algorithm allows information to be recovered from an optimally compressed dataset—it is perhaps most accurately described as an information compression method. Its purpose is not to recover the initial data, but to recover parameters which depend on that initial data. By comparing the Fisher matrix of the data before and after compression, it is shown that the method can be lossless in terms of information although this is not the same as lossless in terms of data.

### Two Parameters

The method outlined above shows how one parameter can be extracted from a dataset. Although this is useful, a more common application would be the calculation of several parameters simultaneously. In order to perform such an analysis a second number, y₂, is used to encapsulate the information from the data about the second parameter, θ₂. In a similar manner to y₁,

y₂≡b₂^{t}x. (1.54)

By construction, y₂ is chosen to be uncorrelated with y₁—this condition is satisfied if b₂^{t}Cb₁=0. It must also contain as much information as possible about θ₂. As explained in HJL00, this requires two Lagrange multipliers (b₂ is normalized by setting b₂^{t}Cb₂=1). This gives

$${b}_{2} = ( {C}^{- 1} {μ}_{, 2} - ( {μ}_{, 2}^{t} {b}_{1} ) {b}_{1} ) / \sqrt{{μ}_{, 2}^{t} {C}^{- 1} {μ}_{, 2} - {( {μ}_{, 2}^{t} {b}_{1} )}^{2}} . \qquad ( 1.55 )$$

It is possible to generalize this solution to M parameters—this requires M orthogonal vectors bₘ=1, . . . M , with each yₘ containing as much information as possible about its corresponding θ_{M} not already contained in y_{q}, q<m. This is essentially the Gram-Schmidt orthogonalisation modified by using C as the curved metric tensor to give the general solution:

$${b}_{m} = ( {C}^{- 1} {μ}_{, m} - {\sum }_{q = 1}^{m - 1} ( {μ}_{, m}^{t} {b}_{q} ) {b}_{q} ) / \sqrt{{μ}_{, m}^{t} {C}^{- 1} {μ}_{, m} - {\sum }_{q = 1}^{m - 1} {( {μ}_{, m}^{t} {b}_{q} )}^{2}} . \qquad ( 1.56 )$$

The remarkable features of this solution are that
The data compression can be massive
There are as many y values as parameters
The Fisher matrix is unchanged by the data compression

A proof that this method is lossless for many parameters is given in the appendix of HJL00. It is important to note that the b-vectors are not unique: they will depend on the order of the parameters. It was shown in RJH01 that this did not influence recovered parameters.

### REFERENCES

HJL00: Heavens, A. F., Jimenez, R., Lahav, O. 2000, MNRAS, 317, 965
RJH01: Reichardt, C., Jimenez, R., Heavens, A. F. 2001, MNRAS, 327, 849
TTH: Tegmark, M., Taylor, A. N., Heavens, A. F. 1997, ApJ, 480, 22

### APPENDIX B

with(linalg);
[BlockDiagonal, GramSchmidt, JordanBlock, LUdecomp, QRdecomp, Wronskian, (1) addcol, addrow, adj, adjoint, angle, augment, backsub, band, basis, bezout, blockmatrix, charmat, charpoly, cholesky, col, coldim, colspace, colspan, companion, concat, cond, copyinto, crossprod, curl, definite, delcols, delrows, det, diag, diverge, dotprod, eigenvals, eigenvalues, eigenvectors, eigenvects, entermatrix, equal, exponential, extend ffgausselim, flbonacci, forwardsub, frobenius, gausselim, gaussjord, geneqns, genmatrix, grad, hadamard, hermite, hessian, hilberi htranspose, ihermite, indexfunc, innerprod, intbasis, inverse, ismith, issimilar, iszero, jacobian, jordan, kernel laplacian, leastsqrs, linsolve, matadd, matrix, minor, minpoly, mulcol, mulrow, multiply, norm, normalize, nullspace, orthog, permanent, pivot, potential, randmatrb randvector, rank, ratform, row, rowdim, rowspace, rowspan, rref, scalarmul, singularvals, smith, stackmatrix, submatrix, subvector, sumbasis, swapcol, swaprow, sylvester, toeplitz, trace, transpose, vandermonde, vecpotent, vectdim, vector, wronskian]

$$\begin{matrix}T := matrix ( 4 , 4 , [ \begin{matrix}1 , 0 , 0 , tx , \\ 0 , 1 , 0 , ty , \\ 0 , 0 , 1 , tz , \\ 0 , 0 , 0 , 1\end{matrix} ] ) ; \\ [ \begin{matrix}1 & 0 & 0 & tx \\ 0 & 1 & 0 & ty \\ 0 & 0 & 1 & tz \\ 0 & 0 & 0 & 1\end{matrix} ] & ( 2 ) \\ Rx := matrix ( 4 , 4 , [ \begin{matrix}1 , 0 , 0 , 0 , \\ 0 , cos ( a ) , sin ( a ) , 0 , \\ 0 , - sin ( a ) , cos ( a ) , 0 , \\ 0 , 0 , 0 , 1\end{matrix} ] ) ; \\ [ \begin{matrix}1 & 0 & 0 & 0 \\ 0 & cos ( a ) & sin ( a ) & 0 \\ 0 & - sin ( a ) & cos ( a ) & 0 \\ 0 & 0 & 0 & 1\end{matrix} ] & ( 3 ) \\ Ry := matrix ( 4 , 4 , [ \begin{matrix}cos ( b ) , 0 , - sin ( b ) , 0 , \\ 0 , 1 , 0 , 0 , \\ sin ( b ) , 0 , cos ( b ) , 0 , \\ 0 , 0 , 0 , 1\end{matrix} ] ) ; \\ [ \begin{matrix}cos ( b ) & 0 & - sin ( b ) & 0 \\ 0 & 1 & 0 & 0 \\ sin ( b ) & 0 & cos ( b ) & 0 \\ 0 & 0 & 0 & 1\end{matrix} ] & ( 4 ) \\ Rz := matrix ( 4 , 4 , [ \begin{matrix}cos ( c ) , sin ( c ) , 0 , 0 , \\ - sin ( c ) , cos ( c ) , 0 , 0 , \\ 0 , 0 , 1 , 0 , \\ 0 , 0 , 0 , 1\end{matrix} ] ) ; \\ [ \begin{matrix}cos ( c ) & sin ( c ) & 0 & 0 \\ - sin ( c ) & cos ( c ) & 0 & 0 \\ 0 & 0 & 1 & 0 \\ 0 & 0 & 0 & 1\end{matrix} ] & ( 5 ) \\ K := matrix ( 4 , 4 , [ \begin{matrix}1 , kxy , kxz , 0 , \\ 0 , 1 , kyz , 0 , \\ 0 , 0 , 1 , 0 , \\ 0 , 0 , 0 , 1\end{matrix} ] ) ; \\ [ \begin{matrix}1 & kxy & kxz & 0 \\ 0 & 1 & kyz & 0 \\ 0 & 0 & 1 & 0 \\ 0 & 0 & 0 & 1\end{matrix} ] & ( 6 ) \\ S := matrix ( 4 , 4 , [ \begin{matrix}sx , 0 , 0 , 0 , \\ 0 , sy , 0 , 0 , \\ 0 , 0 , sz , 0 , \\ 0 , 0 , 0 , 1\end{matrix} ] ) ; \\ [ \begin{matrix}sx & 0 & 0 & 0 \\ 0 & sy & 0 & 0 \\ 0 & 0 & sz & 0 \\ 0 & 0 & 0 & 1\end{matrix} ] & ( 7 ) \\ tmp := multiply ( K , S ) ; \\ [ \begin{matrix}sx & kxy sy & kxzsz & 0 \\ 0 & sy & kyz sz & 0 \\ 0 & 0 & sz & 0 \\ 0 & 0 & 0 & 1\end{matrix} ] & ( 8 ) \\ tmpR := multiply ( Ry , Rz ) ; \\ [ \begin{matrix}cos ( b ) cos ( c ) & cos ( b ) sin ( c ) & - sin ( b ) & 0 \\ - sin ( c ) & cos ( c ) & 0 & 0 \\ sin ( b ) cos ( c ) & sin ( b ) sin ( c ) & cos ( b ) & 0 \\ 0 & 0 & 0 & 1\end{matrix} ] & ( 9 ) \\ R := multiply ( Rx , tmpR ) ; \\ [ \begin{matrix}[ cos ( b ) cos ( c ) , cos ( b ) sin ( c ) , - sin ( b ) , 0 ] , \\ [ \begin{matrix}- cos ( a ) sin ( c ) + sin ( a ) sin ( b ) cos ( c ) , cos ( a ) cos ( c ) + \\ sin ( a ) sin ( b ) sin ( c ) , sin ( a ) cos ( b ) , 0\end{matrix} ] , \\ [ \begin{matrix}sin ( a ) sin ( c ) + cos ( a ) sin ( b ) cos ( c ) , - sin ( a ) cos ( c ) + \\ cos ( a ) sin ( b ) sin ( c ) , cos ( a ) cos ( b ) , 0\end{matrix} ] , \\ [ 0 , 0 , 0 , 1 ]\end{matrix} ] & ( 10 ) \\ tmp 2 := multiply ( R , tmp ) ; \\ [ \begin{matrix}[ \begin{matrix}cos ( b ) cos ( c ) sx , cos ( b ) cos ( c ) kxy sy + \\ cos ( b ) sin ( c ) sy , cos ( b ) cos ( c ) kxz sz + \\ cos ( b ) sin ( c ) kyz sz - sin ( b ) sz , 0\end{matrix} ] , \\ [ \begin{matrix}\begin{matrix}( - cos ( a ) sin ( c ) + \\ sin ( a ) sin ( b ) cos ( c ) sx , ( - cos ( a ) sin ( c ) +\end{matrix} \\ sin ( a ) sin ( b ) cos ( c ) ) kxy sy + ( cos ( a ) cos ( c ) + \\ sin ( a ) sin ( b ) sin ( c ) ) sy , ( - cos ( a ) sin ( c ) + \\ sin ( a ) sin ( b ) cos ( c ) ) kxz sz + ( cos ( a ) cos ( c ) + \\ sin ( a ) sin ( b ) sin ( c ) ) kyz sz + sin ( a ) cos ( b ) sz , 0\end{matrix} ] , \\ [ \begin{matrix}( sin ( a ) sin ( c ) + cos ( a ) sin ( b ) cos ( c ) ) sx , ( sin ( a ) sin ( c ) + \\ cos ( a ) sin ( b ) cos ( c ) ) kxy sy + ( - sin ( a ) cos ( c ) + \\ cos ( a ) sin ( b ) sin ( c ) ) sy , ( sin ( a ) sin ( c ) + \\ cos ( a ) sin ( b ) cos ( c ) ) kxz sz + ( - sin ( a ) cos ( c ) + \\ cos ( a ) sin ( b ) sin ( c ) ) kyz sz + cos ( a ) cos ( b ) sz , 0\end{matrix} ] , \\ [ 0 , 0 , 0 , 1 ]\end{matrix} ] & ( 11 ) \\ A := multiply ( T , tmp 2 ) ; \\ [ \begin{matrix}[ \begin{matrix}cos ( b ) cos ( c ) sx , cos ( b ) cos ( c ) kxy sy + \\ cos ( b ) sin ( c ) sy , cos ( b ) cos ( c ) kxz sz + \\ cos ( b ) sin ( c ) kyz sz - sin ( b ) sz , tx\end{matrix} ] , \\ [ \begin{matrix}\begin{matrix}( - cos ( a ) sin ( c ) + \\ sin ( a ) sin ( b ) cos ( c ) ) sx , ( - cos ( a ) sin ( c ) +\end{matrix} \\ sin ( a ) sin ( b ) cos ( c ) ) kxy sy + ( cos ( a ) cos ( c ) + \\ sin ( a ) sin ( b ) sin ( c ) ) sy , ( - cos ( a ) sin ( c ) + \\ sin ( a ) sin ( b ) cos ( c ) ) kxz sz + ( cos ( a ) cos ( c ) + \\ sin ( a ) sin ( b ) sin ( c ) ) kyz sz + sin ( a ) cos ( b ) sz , ty\end{matrix} ] , \\ [ \begin{matrix}( sin ( a ) sin ( c ) + cos ( a ) sin ( b ) cos ( c ) ) sx , ( sin ( a ) sin ( c ) + \\ cos ( a ) sin ( b ) cos ( c ) ) kxy sy + ( - sin ( a ) cos ( c ) + \\ cos ( a ) sin ( b ) sin ( c ) ) sy , ( sin ( a ) sin ( c ) + \\ cos ( a ) sin ( b ) cos ( c ) ) kxz sz + ( - sin ( a ) cos ( c ) + \\ cos ( a ) sin ( b ) sin ( c ) ) kyz sz + cos ( a ) cos ( b ) sz , tz\end{matrix} ] , \\ [ 0 , 0 , 0 , 1 ]\end{matrix} ] & ( 12 )\end{matrix}$$

1. A process of bringing at least one subject data set into registration or conformity with a reference data set by electronic methods, each of the subject and reference data sets being a representation of a physical object, the process comprising:
generating each of a plurality of candidate data sets by applying a transformation to the reference data set, the transformation having predetermined variables that are changed such that each of the plurality of candidate data sets is a differently shifted or distorted reference data set;
compressing each of the plurality of candidate data sets to form a respective compressed candidate data set and compressing a subject data set to form a compressed subject data set, the step of compressing comprising: determining a plurality of weighting vectors in dependence upon the predetermined variables, the number of weighting vectors being equal to the number of predetermined variables; multiplying all data in a candidate or subject data set by each weighting vector to provide respective, corresponding data elements of the compressed candidate or subject data set;
comparing the compressed subject data set with each of the compressed candidate data sets and, in dependence on the comparisons, determining the transformation that has generated the candidate data set corresponding to the compressed candidate data set, which, of the plurality of compressed candidate data sets, provides a best match with the compressed subject data set; and
applying an inverse of the determined transformation to the subject data set, in which the step of determining a plurality of weighting vectors comprises determining a rate of change of a data set, which is undergoing compression, with respect to at least one of the predetermined variables.

2. A process according to claim 1 in which each of the plurality of weighting vectors is determined in dependence on a rate of change of the data set with respect to a respective one of the predetermined variables.

3. (canceled)

4. A process according to claim 2, in which a rate of change of a data set is determined by: applying each of a plurality of predetermined values for a predetermined variable to the data set to form corresponding intermediate data sets; and determining the rate of change on the basis of the intermediate data sets.

5. A process according to claim 4, in which a rate of change of a data set is determined by: applying a predetermined value that is lower than a nominal value and a predetermined value that is higher than a nominal value for a predetermined variable to the data set to form a first intermediate data set and a second intermediate data set respectively; determining a difference between the first intermediate data set and the second intermediate data set to form a difference data set; and dividing the difference data set by a difference between the positive and the negative predetermined values.

6. (canceled)

7. (canceled)

8. A process according to claim 34, in which a subsequent weighting vector is determined in dependence on: summing products of each previously determined weighting vector with a transpose of the subsequent rate of change; and subtracting the summation from the subsequent rate of change.

9. (canceled)

10. A process according to claim 1, in which the step of determining a plurality of weighting vectors further comprises determining a noise covariance matrix and determining a weighting vector in dependence on a product of a corresponding rate of change and a noise covariance matrix.

11. A process according to claim 1, in which a first weighting vector is:
b₁=C⁻¹μ_{,1}/\sqrt{μ_{,1}^{t}C⁻¹μ_{,1}}
and each subsequent weighting vector is:
$${b}_{m} = ( {C}^{- 1} {μ}_{, m} - {\sum }_{q = 1}^{m - 1} ( {μ}_{, m}^{t} {b}_{q} ) {b}_{q} ) / \sqrt{{μ}_{, m}^{t} {C}^{- 1} {μ}_{, m} - {\sum }_{q = 1}^{m - 1} {( {μ}_{, m}^{t} {b}_{q} )}^{2}}$$
where C is a noise covariance matrix and μ, is the rate of change.

12. A process according to claim 1, in which the step of multiplying all data in a candidate or subject data set by each weighting vector comprises computing the scalar product of the data set and each weighting vector to provide the corresponding, respective data elements.

13. A process according to claim 1, in which the transformation is one of: an affine transformation; and a warp transformation.

14. (canceled)

15. (canceled)

16. (canceled)

17. (canceled)

18. (canceled)

19. (canceled)

20. (canceled)

21. (canceled)

22. (canceled)

23. A process according to claim 1, in which the reference data set and the subject data set are time spaced representations of a physical object.

24. A process according to claim 1, in which a representation is an image of a physical object.

25. (canceled)

26. (canceled)

27. (canceled)

28. A computer program comprising program instructions for causing a computer to perform the process according to claim 1.

29. A computer program according to claim 28, in which the computer program is one of: embodied on a record medium; embodied in a read-only memory; stored in a computer memory; and carried on an electrical carrier signal.

30. A computer system comprising program instructions for causing a computer to perform the process according to claim 1.

31. A computer system according to claim 30, in which the program instructions are one of: embodied on a record medium; embodied in a read-only memory; stored in a computer memory; and carried on an electrical carrier signal.

32. Electrical apparatus operative to bring at least one subject data set into registration or conformity with a reference data set according to the process of claim 1, the electrical apparatus comprising a digital processor and a data store, the digital processor being operative to carry out the steps of: generating each of the plurality of candidate data sets; compressing each of the plurality of data sets and compressing the subject data set; comparing the compressed subject data set with each of the compressed candidate data sets; and applying the inverse of the determined transformation, and the data store being operative to store: the at least one subject data set and the reference data set; the plurality of candidate data sets; and the compressed data sets.

33. (canceled)

34. A process according to claim 1, in which a first weighting vector is determined in dependence on a first rate of change determined with respect to a first predetermined variable and a second weighting vector is determined in dependence on the first weighting vector and a second rate of change determined with respect to a second predetermined variable.

35. A process according to claim 34, in which the second weighting vector is determined in dependence on subtraction of a product of the first weighting vector and a transpose of the second rate of change from the second rate of change.
